(19) United States
(12) Patent Application Publication
(10) Pub. No.: US 2005/0288390 A1
(43) Pub. Date: Dec. 29, 2005

(54) Method of producing a digital printing ink and ink thus obtained

(76) Inventor: Antonio Lopez Munoz, Igualada (ES)

Correspondence Address: FLESHNER & KIM, LLP, P.O. BOX 221200, CHANTILLY, VA, 20153, US

(21) Appl. No.: 10/525,510

(22) PCT Filed: Jul. 31, 2003
(86) PCT No.: PCT/ES03/00401

§ 371 Date: Aug. 16, 2005

(30) Foreign Application Priority Data
Aug. 27, 2002 (ES) P 20020198.3

(51) Int. Cl. C03C 17/00; C09D 11/00

(52) U.S. Cl. 523/160; 523/161

(57) ABSTRACT

The invention relates to a method of producing a digital printing ink and to the ink thus obtained. The inventive method comprises the following steps consisting in: dispersing colouring agents in a mixture of oligomers and monomers with a maximum particle size of 1 micrometer; diluting same with a mixture of monofunctional and multifunctional acrylic monomers until a viscosity of between 10 and 30 centipoises is obtained; introducing a photoinitiator system which causes the polymerisation of the oligomers and monomers from the first step, in the presence of radiation; and subjecting the resulting ink to a filtering process.

Method of producing a digital printing ink characterized by including the following steps: dispersing coloring agents in a mixture of oligomers and monomers with a maximum particle size of 1 micron; diluting same with a mixture of monofunctional and multifunctional acrylic monomers until a viscosity of between 10 and 30 centipoises is obtained; introducing a photoinitiator system which causes the polymerization of the oligomers and monomers from the first step, in the presence of ultraviolet radiation; and subjecting the resulting ink to a filtration process.

### BACKGROUND OF THE INVENTION

Different state-of-the-art procedures and sublimating inks are known for digital printing. Specifically, waterbased inks.

Other digital inks can be for laser printers. These inks start out with toner or powdered ink and through an electrostatic charge from the printer transfer the ink using a laser beam.

Also known are inkjet inks that use nozzles to direct the ink using previously digitized information from the computer.

Computer to Plate printing inks are also known, consisting of a previously created computer file, which will make the electronic stamping on the plates.

In fact, the vast majority of inks known to date follow the same scheme:

A sublimatable coloring agent or mixture of coloring agents to which a soluble resin is added to be used as a medium.

Then, an organic solvent is introduced (water-based or pure), or a mixture of a water-based organic solvent and a pure one.

Finally, a resin is used as a thickening agent or as adhesive for the ink.

Also, it can be noted that resins can be identical and that they can include additives like ethyl alcohol or butanol, among others.

This outline is followed by the 1973 Spanish patent No. 413.791 from CIBA-GEIGY AG, consisting of a method to prepare printing inks for printing by transference through sublimation, where the advantage is in allowing the combination of concentrated preparations rich in coloring agents.

U.S. Pat. No. 6,383,274 describes an inkjet water-based printing ink in which the printing bleeding agent includes a fluorinated composition, specifically a perfluoroalkyl acid salt. This patent underlines that the advantages of these inks are: reduction of drying time and, specially, prevention of ink bleeding.

### BRIEF DESCRIPTION OF THE REQUESTED INVENTION

The present invention is an advancement in the field of ink production, particularly inks for digital printing.

Such inks, once printed on the media, are dried through radiation, which causes the polymerization of the ink, and results in an immediate fixation to the media as well as feeling dry to the touch.

Previously mentioned inks, including those known as state-of-the-art digital printing inks, have the inconvenience of “moving” when transferring the dispersing coloring agent to the fabric through pressure and heat, resulting in designs that are not perfect.

This ink completely changes the concept of previously mentioned inks because it has a sublimatable coloring agent or mixture of coloring agents but lacks any kind of resin used as a medium, or any organic solvent or resin that might serve as thickening agent, because its special composition makes this unnecessary.

All of this because the medium for the procedure is formed at the time of the polymerization of the monomers and oligomers.

At the same time, monomers and oligomers themselves act as solvents, thus forming the resin at the time of polymerization.

For all these reasons, the use of water or other solvents is not necessary in order to produce this ink.

### Specific Process for the Requested Patent

Thus, the specific process for the present invention requires that in order to produce an ink-jet digital printing ink, the following steps must be completed:

For the first step, proceed to the dispersion of coloring agents in a mixture of oligomers and monomers, in such a way that the maximum size of the particle would not be more than 1 micron.

Such dispersion of coloring agents is obtained by using a high energy ball mill, combined with the application of a constant temperature between 35° C. and 80° C., milling until an average particle size between 0.1 and 0.8 microns is obtained, and combining all of the above with a mixture of monomers and dispersants, in order to avoid re-agglomeration of dispersing coloring agents.

This is subsequently diluted with a mixture of monofunctional and multifunctional acrylic monomers until a viscosity between 10 and 30 centipoises is achieved.

Thus, regarding this monofunctional acrylic monomer, the ideal ratio is the one found between 25% and 55% of total acrylic monomers. This specific process uses Isobornyl Acrylate.

Of the multifunctional acrylic monomers, between 44% and 75% of total acrylic monomers, those that are bifunctional or trifunctional must be differentiated.

Among bifunctional acrylic monomers, Hexandioldiacrylate and Tripropyleneglycoldiacrylate will be used for this specific process.

Among trifunctional acrylic monomers, Trimethylolpropanetriacrylate will be used.

Then, a photoinitiator system is introduced, which starts the polymerization of the oligomers and monomers from the first step, because of the liberation of radicals after being subject to a radiation source.

Later, once the ink formulation is finished, and the desired viscosity has been obtained, the resulting ink is subject to a filtration process in order to retain particles by means of successive filters ending with a 1 micron filter, retaining all those particles bigger than 1 micron.

This ink is particularly useful for printing on flexible media, such as paper, plastified elements, plastic films, etc.

Such flexible media, through drop-on-demand piezoelectric heads, also known in the industry as ink-jets, eject ink drops until the desired image or picture is formed.

Once the resulting ink has been printed on a media, a radiation source is applied on the ink, i.e. the light from an ultraviolet lamp or through electron bombing, which fracture the molecules of the photoinitiator system, turning them into free radicals that react, violently and quickly, to the oligomers and monomers, resulting in a polymer that sets the dispersing coloring agents on the printed media.

These printed media can be stored until they are needed for later use.

When it becomes necessary to place the printed media on a surface, i.e. fabric, apply the printed media to the fabric, specifically the back of the surface to be printed, and with a temperature starting at 150° C., apply pressure for at least 10 seconds.

Once the required time has lapsed, separation of the printed media from the surface of the fabric will result in the inking of the fabric by the dispersing coloring agent of the formula, placing the ink film over the printed media.

This is the result of taking advantage of the known properties of certain dispersing coloring agents capable of high temperature sublimation, which allows them to leave the ink film and ink the fabric.

At the same time, the inventor has been able to test that synthetic fiber fabric that has been printed with the above mentioned ink does not require any further treatment to assure resistance after being washed.

On the other hand, natural fiber fabric that has been printed with ink from this invention will require a pre-treatment to assure resistance.

This invention patent describes a new method of producing a digital printing ink and the ink thus obtained. The examples mentioned herein are not limited to this invention and will therefore have different applications and/or adaptations, all of them within the scope of the following claims.

1-18. (canceled)

19. A method of producing a digital printing ink, comprising:
dispersing coloring agents in a mixture of oligomers and monomers with a maximum particle size of 1 micron;
diluting same with a mixture of monofunctional and multifunctional acrylic monomers until a viscosity of between 30 and 30 centipoises is obtained;
introducing a photoinitiator system, which causes the polymerization of the oligomers and monomers from the first step, in the presence of radiation; and
subjecting the resulting ink to a filtering process, to obtain particles by means of at least one filter, finalizing with a 1 micron filter characterized by the production of free radicals that react with the oligomers and monomers when the resulting ink is printed on a media and the referred radiation source is applied to this ink, fracturing the molecules of the photoinitiator system, thus producing a polymer that sets the dispersing coloring agents on the media.

20. The method according to claim 19, characterized by having Isobornyl Acrylate among the multifunctional acrylic monomers, with a ratio of 25% to 55% of total acrylic monomers.

21. The method according to claim 19, characterized by having bifunctional and trifunctional multifunctional acrylic monomers with a ratio of 44% to 75% of total acrylic monomers.

22. The method according to claim 21, characterized by having Hexandioldiacrylate among the bifunctional acrylic monomers.

23. The method according to claim 21, characterized by having Tripropyleneglycoldiacrylate among the bifunctional acrylic monomers.

24. The method according to claim 21, characterized by having Trimethylolpropanetriacrylate among the trifunctional acrylic monomers.

25. The method according to claim 19, characterized by having the source of radiation be at least one source of ultraviolet light.

26. The method according to claim 19, characterized by having the source of radiation be a bombardment of electrons.

27. A digital printing ink produced according to the method of claim 1, wherein coloring agents are dispersed in an organic medium dispersed in a mixture of oligomers and monomers with a maximum particle size of 1 micron; diluting it with a mixture of monofunctional and multifunctional acrylic monomers until a viscosity of between 10 and 30 centipoises is obtained; with a photoinitiator system which causes the polymerization of the oligomers and monomers from the first step, subjecting the resulting ink to at least one filter, finalizing with a 1 micron filter characterized by having:
Isobornyl Acrylate as the multifunctional acrylic monomer, with a ratio of 25% to 55%; and
bifunctional and trifunctional multifunctional acrylic monomers; with a ratio of 44% to 75%.

28. The ink according to claim 27, characterized by having Hexandioldiacrylate among the bifunctional acrylic monomers.

29. The ink according to claim 27, characterized by having Tripropyleneglycoldiacrylate among the bifunctional acrylic monomers.

30. The ink according to claim 27, characterized by having Trimethylolpropanetriacrylate among the trifunctional acrylic monomers.
